(19) United States
(12) Patent Application Publication
(10) Pub. No.: US 2006/0120698 A1
(43) Pub. Date: Jun. 8, 2006

(54) Recorder, reproducing device and editor

(75) Inventor: Takeshi Kobayashi, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/265,178

(22) Filed: Nov. 3, 2005

(30) Foreign Application Priority Data
Nov. 4, 2004 (JP) P2004-321052
Nov. 4, 2004 (JP) P2004-321053
Nov. 4, 2004 (JP) P2004-321054

(51) Int. Cl. H04N 5/85

(52) U.S. Cl. 386/126

(57) ABSTRACT

In a recorder, since an AV signal inputted to an input part is temporarily recorded on a sub-recording medium and then recorded on an optical disk with a delay of a prescribed time or more, there is a deviation in time until a second encoding part encodes the AV signal inputted to the input part when the setting of an encode rate is changed. Accordingly, when the change of the setting of the encode rate is received, the setting of an encode rate relative to the AV signal inputted to the input part can be smoothly changed. Advantageously, the record of the AV data of the AV signal inputted to the input part is not interrupted when the change of the setting of the encode rate is received.

### BACKGROUND OF THE INVENTION

1. Field of the Invention

The present invention relates to a recorder for recording an image on an optical disk such as a CD, a DVD, or the like, and particularly to a recorder that can set an encode rate of the image recorded on the optical disk.

Also, the present invention relates to a reproducing device for reproducing moving image data recorded on a recording medium such as a DVD, a hard disk, etc.

Further, the present invention relates to an editor for recording moving image data on a second recording medium when the moving image data recorded on a first recording medium such as an optical disk (CD, DVD or the like) or a hard disk.

2. Description of the Related Art

Usually, a recorder for recording an externally inputted image on an optical disk such as a CD or a DVD has been put to practical use and ordinarily propagated. In such kind of recorder, the image data of the inputted image is encoded (compressed) by an MPEG or the like and the encoded data is recorded on the optical disk. When an encode rate is increased, the capacity of the encoded image data is reduced. Accordingly, a recording time for which the image data can be recorded on the optical disk is lengthened, however, the quality of a reproduced image is deteriorated when the recorded image data is reproduced. Thus, recorders having below-described structures are proposed. They include a recorder in which the encode rate of an image recorded by a user can be set, a recorder (see JP-A-9-284715) in which the setting of the encode rate is changed in accordance with the time length of a program to be recorded and the space capacity of an optical disk (an optical disk set in a main body) for recording the program and a recorder (see JP-A-2004-186845) in which a relatively low encode rate is set to a program that the user looks at and listens to with a high possibility on the basis of a viewing history of the user and a relatively high encode rate is set to other programs (programs that the user looks at and listens to with a low possibility).

In a television broadcasting, commercials or an explanation of main edition of a program are broadcast during the main edition of the broadcast program. Accordingly, when the program of the television broadcasting is recorded on the recording medium, not only the main edition of the program, but also the commercials or the explanation of the main edition of the program broadcast during the main edition of the program are also recorded. A usual reproducing device has a skipping function for skipping (quick feed reproduction) parts unnecessary for the user to view such as the commercials or the explanation of the main edition of the program when the program recorded on the recording medium is reproduced (ordinary reproduction) at an ordinary speed.

Further, an editor in which moving image data recorded on one recording medium can be edited and recorded on the other recording medium is also put to practical use. This editor has a structure for reproducing the moving image data recorded on one recording medium and a structure for recording the moving image data of a moving image during a reproducing operation on the other recording medium.

### SUMMARY OF THE INVENTION

However, in the usual recorder, during a recording operation that the inputted image is recorded on the optical disk, the user cannot change the set encode rate. Accordingly, when a program broadcast by a television is recorded on the optical disk, parts unnecessary for the user such as commercials broadcast during the program to be recorded or an explanation of the program (for instance, an explanation of a movie) are also recorded on the optical disk at the same encode rate as that of a main edition of the program. Ordinarily, it is the main edition of the program that the user desires to record the image on the optical disk with a high quality of image. Thus, even when the images of the explanation of the main edition of the program or the commercials are recorded with a low quality (a high encode rate), a problem does not occur. As described above, in the usual recorder, since even the parts unnecessary for the user to record the images with the high quality are recorded at the same encode rate as that of the main edition of the program, the recording capacity of the optical disk cannot be efficiently employed, thereby resulting in an unsatisfactory maneuver ability for the user.

Also, in the skipping function provided in the usual ordinary reproducing device, when an input operation for performing the skipping function is carried out, a quick feed reproduction is carried out for a prescribed time (in many cases, 15 seconds corresponding to a time for one average commercial, and then, the quick feed reproduction is returned to an ordinary reproduction. Therefore, every time the reproducing position of a program recorded on a recording medium comes to a part unnecessary for a user, the user needs to carry out the input operation for performing the skipping function. Thus, undesirably, the operation of the user during a reproducing operation is complicated and maneuverability is not good.

Further, JP-A-2004-186845 discloses that “a function may be provided for performing an operation for skipping next commercials and reproducing data during are production by using a difference of the bit rates of recorded images.” (paragraph number [0026]). However, a specific description is not made as to how the difference of the bit rates (difference of encode rates) is detected or what skipping operation is carried out.

When the program of a television broadcasting recorded on a recording medium (one recording medium) is edited for recording on another recording medium (the other recording medium), most of users desire to cut unnecessary parts for the user and record only the main edition of the program as an object to be viewed on the other recording medium to more efficiently use the recording capacity of the recording medium. In a usual editor, to cut the unnecessary parts for the user and record only the main edition of the program on the other recording medium, the user needs to repeatedly perform operations such as start to reproduce the program recorded on the one recording medium, start to record the program in the other recording medium, temporarily stop the record to the other recording medium at the starting position of the unnecessary parts for the user that exist during the main edition of the program, and cancel the temporary stop of the record to the other recording medium at a position (a resuming position) where the unnecessary parts for the user are finished and the main edition of the program is resumed for each position where parts to be cut (unnecessary parts for the user) are present. Therefore, an editing operation is complicated and takes much time and labor so that maneuverability is disadvantageously not good.

Even in the recording medium in which the commercials broadcast during the main edition of the program are recorded at the relatively high encode rate and the main edition of the program is recorded at the relatively low encode rate as in the device disclosed in JP-A-2004-186845, the above-described operations need to be carried out in an editing operation for cutting the commercials to record the main edition of the program on the other recording medium.

It is an object of the present invention to provide a recorder in which the setting of an encode rate can be simply changed during a recording operation that an inputted image is recorded on an optical disk, and the recording capacity of the optical disk for recording the image can be effectively used.

It is another object of the present invention to provide a reproducing device that automatically switches an ordinary reproduction for a main edition of a program and a quick feed reproduction for unnecessary parts when a recording medium is reproduced in which data is recorded in such a way that an encode rate of the parts unnecessary for the user is made to be higher than that of the main edition of the program so that the operability of the user is improved during the reproducing operation.

It is still another object of the present invention to provide an editor that can simply cut unnecessary parts for a user and record only a main edition of a program on the other recording medium by using a recording medium in which the unnecessary parts for the user broadcast during the main edition of the program are recorded at the relatively high encode rate and the main edition of the program is recorded at the relatively low encode rate.

In order to solve the above-described problems, a recorder of the present invention includes the following structure.

(1) A recorder having a recording unit for recording an inputted image on an optical disk comprises:

an image input receiving unit for receiving the input of the image;

a first encoding unit for encoding the image received by the image input receiving unit;

a sub-recording unit for recording image data encoded by the first encoding unit on a sub-recording medium; a decoding unit for decoding the image data recorded on the sub-recording medium by the sub-recording unit;

a second encoding unit for encoding the image data decoded by the decoding unit at the set encode rate; and

an encode rate receiving unit for receiving the input of the setting of the encode rate in the second encoding unit.

The recording unit serves to record the image data encoded by the second encoding unit on the optical disk. The first encoding unit serves to encode the image received by the image input receiving unit at a prescribed encode rate.

The decoding unit serves to decode the image data of the image whose input is received by the image input receiving unit before a predetermined prescribed time or more.

The second encoding unit serves to encode an image subsequently received by the image input receiving unit at a setting changed encode rate, when the encode rate receiving unit receives an input of the setting change of the encode rate.

According to this structure, the first encoding unit encodes the image received by the image input receiving unit and the sub-recording unit records the encoded image data on the sub-recording medium. The decoding unit decodes the image data recorded on the sub-recording medium for the image with an elapse of a prescribed time or more after the image input receiving unit receives the image. The second encoding unit encodes the decoded image data at the set encode rate and the recording unit records the image data encoded by the second encoding unit on the optical disk. In such a way, the image received by the image receiving unit is temporarily recorded on the sub-recording medium and then, recorded on the optical disk.

Further, when the encode rate receiving unit receives an input of the change of the setting of the encode rate, the second encoding unit switches the encode rate of the image subsequently received by the image input receiving unit to an encode rate whose setting is changed this time. As described above, the image received by the image input receiving unit is temporarily recorded on the sub-recording medium, and then recorded on the optical disk. Accordingly, when the input concerning the change of the setting of the encode rate is received, there is a deviation in time until the second encoding unit encodes the image received by the image input receiving unit. Therefore, after the change of the setting of the encode rate is received, the encode rate of the image received by the image input receiving unit can be smoothly switched. Accordingly, while the image is recorded on the optical disk, the encode rate of the recorded image can be switched. Thus, for instance, when a user records a broadcast program, the user operates to set the encode rate to a high encode rate at a timing when the program is changed to parts unnecessary for the user such as commercials or an explanation of a main edition of the program and operates to set the encode rate to a low encode rate when the parts unnecessary for the user are changed to the main edition of the program. Thus, the program can be recorded on the optical disk with a high image quality and the parts unnecessary for the user such as the commercials or the explanation of the main edition of the program that are broadcast during the program can be recorded with a low image quality, so that the recording capacity of the optical disk can be efficiently used.

(2) The sub-recording unit has a function for deleting the image data decoded by the decoding unit.

According to this structure, since unnecessary image data is not continuously recorded on the sub-recording medium for a long time, the recording capacity of the sub-recording medium can be efficiently used and the recording capacity necessary for the sub-recording medium is suppressed.

Since the image data decoded by the decoding unit is subsequently recorded on the optical disk, the image data may be deleted from the sub-recording medium without a problem.

(3) The encode rate receiving unit serves to receive a selection of the encode rates that are previously determined stepwise and the first encoding unit serves to encode the image received by the image input receiving unit at the lowest encode rate of the encode rates that are previously determined stepwise.

According to this structure, the first encoding unit encodes the image at the lowest encode rate (an encode rate at which the deterioration of the image quality of a reproduced image is minimum) of the predetermined encode rates. Accordingly, in a pre-process before the second encoding unit encodes the image data to be recorded on the optical disk, the deterioration of the image quality can be suppressed.

(4) The encode rate receiving unit serves to receive a setting input for inhibiting the image data decoded by the decoding unit from being recorded on the optical disk by the recording unit.

According to this structure, since the image data can be inhibited from being recorded on the optical disk, an operation can be carried out for inhibiting the image of a commercial broadcast during a recorded program from being recorded on the optical disk. Thus, the recording capacity of the optical disk can be more efficiently used.

According to the present invention, while the image is recorded on the optical disk, the encode rate of the recorded image can be changed. Thus, the user can record the program on the optical disk with the high image quality and unnecessary parts for the user such as the commercials or the explanation of the main edition of the program with the low image quality. Accordingly, the recording capacity of the optical disk can be efficiently used and maneuverability for the user can be improved.

In order to solve the above-described problems, a reproducing device of the present invention includes the following structure.

(1) A reproducing device has a reading unit for reading moving image data encoded from a recording medium; a decoding unit for decoding the moving image data read by the reading unit; and a reproducing unit for generating a reproducing signal based on the moving image data decoded by the decoding unit and outputting the reproducing signal. The reproducing device comprises:

a deciding unit for temporarily holding the moving image data decoded by the decoding unit and deciding whether or not the encode rate of the moving image data of a moving image during a reproducing operation is higher than a predetermined level on the basis of an amount of use of a memory employed as a working area during a decoding operation; and

a skipping unit for instructing the reproducing unit to start a quick feed reproduction when the deciding unit decides that the encode rate is higher than the predetermined level, and then, instructing the reproducing unit to return to an ordinary reproduction from the quick feed reproduction when the deciding unit decides that the encode rate is lower than the predetermined level.

In this structure, in the decoding unit, the moving image data read from the recording medium such as the DVD (optical disk) or the hard disk by the reading unit is decoded. The reproducing unit generates the reproducing signal based on the decoded moving image data and outputs the reproducing signal. The deciding unit temporarily holds the moving image data decoded by the decoding unit and decides whether or not the encode rate of the moving image data of a moving image during a reproducing operation is higher than a predetermined level on the basis of an amount of use of a memory employed as a working area during a decoding operation. When the deciding unit decides that the encode rate is higher than the predetermined level, the skipping unit instructs the reproducing unit to start a quick feed reproduction. The reproducing unit starts the quick feed reproduction in accordance with the instruction. Then, when the deciding unit decides that the encode rate is lower than the predetermined level, the skipping unit instructs the reproducing unit to return to an ordinary reproduction from the quick feed reproduction. The reproducing unit completes the quick feed reproduction and returns to the ordinary reproduction in accordance with the instruction.

Accordingly, during the reproduction of the moving image data recorded on the recording medium, a switching operation is automatically carried out that the quick feed reproduction is performed for the moving image data recorded at the encode rate higher than the predetermined level and the ordinary reproduction is performed for the moving image data recorded at the encode rate lower than the predetermined level. To efficiently use the recording capacity of the recording medium on which the moving image data is recorded, the encode rate to parts unnecessary for a user such as commercials or an explanation of a main edition of a program is ordinarily made to be higher than that of the main edition of the program. When the recording medium is reproduced in which the encode rate to the commercials is made to be higher than that of the main edition of the program to record the data at the encode rate higher than the predetermined level, the parts unnecessary for the user are automatically quickly fed and reproduced, so that the operability of the user can be improved.

(2) When the reproducing unit is instructed to return to the ordinary reproduction from the quick feed reproduction by the skipping unit, the reproducing unit resumes the ordinary reproduction from a position where the reproducing unit returns by a prescribed amount on this side of a position where the moving image data of the encode rate higher than the predetermined level is changed to the moving image data of the encode rate lower than the predetermine level.

In this structure, since the reproducing unit returns the quick feed reproduction to the ordinary reproduction at a position a prescribed amount before a position where the parts unnecessary for the user are changed to the main edition of the program, for instance, a position 1 to 2 seconds before the ordinary reproduction, a situation is prevented from arising that a moving image is disturbed immediately after the parts unnecessary for the user are changed to the main edition of the program to hinder the user from viewing the moving image.

(3) A switching unit is further included for switching whether the skipping unit is made to be valid or invalid.

In this structure, since the skipping unit can be switched to be valid or invalid, even in the recording medium on which the moving image is recorded at the encode rate higher than the predetermined level, the skipping unit is set to be invalid so that the moving image data recorded on the recording medium can be ordinarily reproduced. Accordingly, the moving image data recorded at the encode rate higher than the predetermined level can be viewed under the ordinary reproduction.

According to the present invention, during the reproduction of the moving image data recorded on the recording medium, the quick feed reproduction is performed for the moving image data recorded at the encode rate higher than the predetermined level and the ordinary reproduction is performed for the moving image data recorded at the encode rate lower than the predetermined level. To efficiently use the recording capacity of the recording medium on which the moving image data is recorded, the encode rate to the parts unnecessary for the user is ordinarily made to be higher than that of the main edition of the program. Accordingly, when the recording medium is reproduced in which the encode rate to the parts unnecessary for the user is made to be higher than that of the main edition of the program to record the data at the encode rate higher than the predetermined level, the commercial parts are automatically quickly fed and reproduced, so that the operability of the user can be improved.

An editor of the present invention includes the following structure in order to solve the above-described problems.

(1) An editor has a reading unit for reading moving image data encoded from a first recording medium; a decoding unit for decoding the moving image data read by the reading unit; and a reproducing unit for generating a reproducing signal based on the moving image data decoded by the decoding unit and outputting the reproducing signal. The reproducing unit includes a recording unit for recording the moving image data of a moving image during a reproducing operation on a second recording medium. The editor comprises: a deciding unit for temporarily holding the moving image data decoded by the decoding unit and deciding whether or not the encode rate of the moving image data of the moving image during the reproducing operation is higher than a predetermined level on the basis of an amount of use of a memory employed as a working area during a decoding operation; and a record inhibiting unit for inhibiting the recording unit from recording the moving image data of the moving image during the reproducing operation on the second recording medium while the reproducing unit reproduces the moving image data having the encode data decided to be higher than the predetermined level by the deciding unit.

In this structure, in the decoding unit, the moving image data read from the first recording medium such as the optical disk such as a CD, a DVD, etc. by the reading unit is decoded. The reproducing unit generates the reproducing signal based on the decoded moving image data and outputs the reproducing signal. Further, the recording unit records the moving image data of the moving image during the reproducing operation on the second recording medium. The deciding unit temporarily holds the decoded moving image data and decides whether or not the encode rate of the moving image data of the moving image during the reproducing operation is higher than the predetermined level on the basis of an amount of use of the memory employed as a working area during the decoding operation. The record inhibiting unit inhibits the recording unit from recording the moving image data of the moving image during the reproducing operation on the second recording medium while the reproducing unit reproduces the moving image data having the encode data decided to be higher than the predetermined level by the deciding unit.

Accordingly, the moving image data recorded on the first recording medium at the encode rate higher than the predetermined level is not recorded on the second recording medium. Only the moving image data recorded on the first recording medium at the encode rate lower than the predetermined level is recorded on the second recording medium. Many users already ordinarily record the moving image data on the recording medium in such a way that the encode rate to parts unnecessary for the user such as commercials or an explanation of a main edition of a program is made to be higher than that of the main edition of the program. Further, the device for recording the moving image data on the recording medium has been already proposed as described above that the encode rate to parts unnecessary for the user is made to be higher than that of the main edition of the program.

According to the present invention, when a recording medium (a first recording medium) is used in which the unnecessary parts for the user are recorded at the encode rate higher than that of the main edition of the program and higher than the predetermined level, the unnecessary parts for the user can be automatically cut and only the main edition of the program can be recorded on the second recording medium. Thus, an editing operation that the unnecessary parts for the user are cut from one recording medium and only the main edition of the program is recorded on the other recording medium (a second recording medium) can be simply carried out and the maneuverability of the user can be improved.

The first recording medium and the second recording medium may be the optical disks (the CD, the DVD, etc.) or the hard disks and the types of them are not especially limited to specific media. The kinds of the first recording medium and the second recording medium may the same or different.

(2) The recording unit is a unit for directly recording the moving image data read from the first recording medium by the reading unit on the second recording medium.

According to this structure, since the moving image data read from the first recording medium is directly recorded on the second recording medium, the image quality of a reproduced image in the moving image data recorded on the second recording medium is not deteriorated by an editing operation.

(3) A switching unit is further provided for switching whether the recording unit is made to be valid or invalid.

According to this structure, whether the inhibiting unit is made to be valid or invalid can be switched, even when the moving image is recorded on the first recording medium at the encode rate higher than the predetermined level, the inhibiting unit is set to be invalid so that the moving image can be recorded on the second recording medium.

(4) A skipping unit is further provided for instructing the reproducing unit to start a quick feed reproduction when the deciding unit decides that the encode rate is higher than the predetermined level, and then, instructing the reproducing unit to return to an ordinary reproduction from the quick feed reproduction when the deciding unit decides that the encode rate is lower than the predetermined level.

According to this structure, since the unnecessary parts for the user recorded at the encode rate higher than the predetermined level are automatically quickly fed and reproduced, a time necessary for an editing operation is shortened that the unnecessary parts for the user are cut from one recording medium and only the main edition of the program is recorded on the other recording medium.

According to the present invention, the moving image data recorded on the first recording medium at the encode rate higher than the predetermined level is not recorded on the second recording medium. Only the moving image data recorded on the first recording medium at the encode rate lower than the predetermined level is recorded on the second recording medium. Accordingly, as already generally performed, when a recording medium (a first recording medium) is used in which the unnecessary parts for the user are recorded at the encode rate higher than that of the main edition of the program and higher than the predetermined level, the unnecessary parts for the user can be automatically cut and only the main edition of the program can be recorded on the second recording medium. Thus, an editing operation that the unnecessary parts for the user are cut from one recording medium and only the main edition of the program is recorded on the other recording medium can be simply carried out and the maneuverability of the user can be improved.

### BRIEF DESCRIPTION OF THE DRAWINGS

FIG. 1 is a diagram showing the structure of main parts of a recorder of an embodiment of the present invention;

FIG. 2 is a flowchart showing a recording operation in a pre-stage part of the recorder of the embodiment of the present invention;

FIG. 3 is a flowchart showing a recording operation in a post-stage part of the recorder of the embodiment of the present invention;

FIG. 4 is a flowchart showing a recording operation in a post-stage part of a recorder of another embodiment of the present invention;

FIG. 5 is a diagram showing the structure of main parts of a reproducing device of an embodiment of the present invention;

FIG. 6 is a flowchart showing the operation of the reproducing device of the embodiment of the present invention;

FIG. 7 is a flowchart showing a reproducing operation in the reproducing device of the embodiment of the present invention;

FIG. 8 is a diagram showing the structure of main parts of an editor of an embodiment of the present invention;

FIG. 9 is a flowchart showing the operation of the editor of the embodiment of the present invention;

FIG. 10 is a flowchart showing an editing operation in the editor of the embodiment of the present invention; and

FIGS. 11A and 11B are diagrams for explaining moving image data recorded from one DVD to the other DVD in the editing operation of the editor of the embodiment of the present invention.

### DETAILED DESCRIPTION OF THE PREFERRED EMBODIMENTS

Now, a recorder of an embodiment of the present invention will be described below.

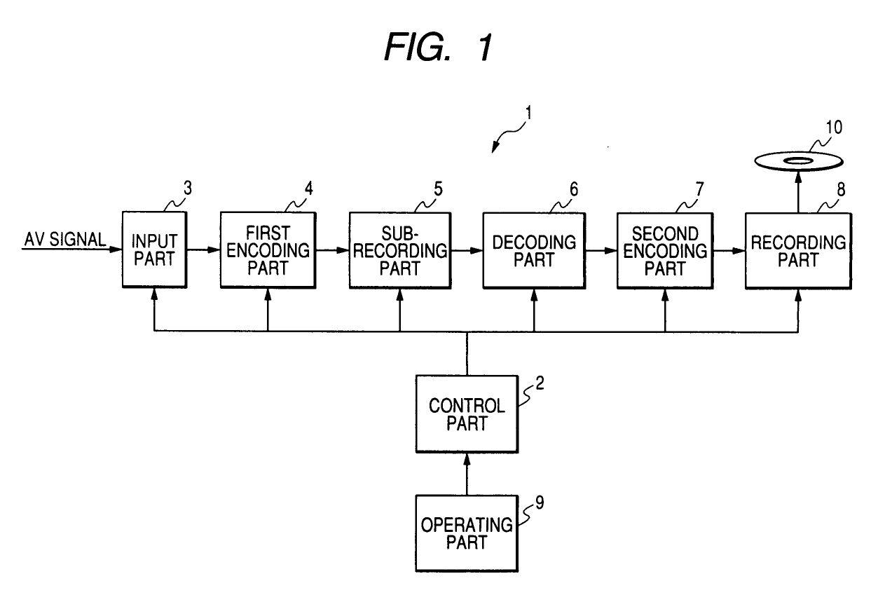

FIG. 1 is a diagram showing the structure of main parts of a recorder of the embodiment of the present invention. The recorder 1 of this embodiment includes a control part 2 for controlling the operation of a main body, an input part 3 to which an AV signal (Audio Visual signal) is inputted, a first encoding part 4 for encoding the AV signal (a video signal and an audio signal) inputted to the input part 3, a sub-recording part 5 for temporarily recording AV data encoded by the first encoding part 4 in a sub-recording medium, a decoding part 6 for decoding the AV data recorded in the sub-recording medium, a second encoding part 7 for encoding again the AV data decoded by the decoding part 6, a recording part 8 for recording the AV data encoded in the second encoding part 7 on an optical disk 10 such as a DVD and an operating part 9 for receiving an input operation to the main body.

The input part 3 is a well-known tuner for receiving a television broadcasting signal and extracting the television broadcasting signal of a selected channel. The first encoding part 4 encodes the AV signal of the channel extracted by the input part 3 at the encode rate under which the deterioration of an image quality is low. The encode rate to the first encoding part 4 is fixed and cannot be changed by a user. The sub-recording part 5 has a hard disk as the sub-recording medium to record the AV data encoded by the first encoding unit on this hard disk. The sub-recording part 5 may record the AV data encoded by the first encoding unit on other recording medium than the hard disk, for instance, an optical disk or a memory.

The decoding part 6 decodes the AV data (AV data recorded in the sub-recording medium) of the AV signal that remains for a predetermined prescribed time or more after the AV signal is inputted to the input part 3. The second encoding part 7 encodes the AV data decoded in the decoding part 6 at the set encode rate. As for the encode rate in the second encoding part 7, the user can select an encode rate from encode rates (E1 to E5) of five stages that are previously determined stepwise. Herein, E1 is a minimum encode rate and E5 is a maximum encode rate. The encode rate in the second encoding part 7 is set by the operating part 9. The operating part 9 has a receiving part for receiving a control signal transmitted from a remote controller not shown in the drawing as well as keys for performing the input operation to the main body. The user can perform an operation for setting the encode rata in the second encoding part 7 by using the remote controller not illustrated. In the operating part 9, keys operated when the encode rates E1 to E5 are selected are individually provided and the user can set the encode rate in the second encoding part 7 by the one-touch operation of the key. Further, also in the remote controller, keys operated when the encode rates E1 to E5 are similarly selected are individually provided. The encode rate in the first encoding part 4 is E1 and fixed as described above. The recording part 8 records the AV data encoded in the second encoding part 7 in the optical disk 10. The recording part 8 has a function for reading the AV data recorded in the optical disk 10. The decoding part 6 has a function for decoding the AV data read by the recording part 8 from the optical disk 10 and outputting the decoded AV data to an external part. Further, the input part 3 has a function for outputting the inputted AV signal to the external part. By a television receiver connected to the recorder 1, a video or an audio based on the AV signal inputted to the input part 3 or a video or an audio based on the AV data read from the optical disk 10 by the recording part 8 can be looked at or listened to.

In the recorder of this embodiment, according to the above-described structure, the AV signal inputted to the input part 3 is encoded by the first encoding part 4 at the encode rate of E1 and the encoded AV data is recorded in the sub-recording medium by the sub-recording medium 5. This process is referred to as a process of a pre-stage part. Further, the decoding part 6 decodes the AV data recorded in the sub-recording medium with an elapse of a prescribed time or more after the signal is inputted to the input part 3. The second encoding part 7 encodes the decoded AV data at the set encode rate and the recording part 8 records the AV data encoded in the second encoding part 7 on the optical disk 10. Here, this process is referred to as a process of a post-stage part. As described above, in the pre-stage part, the AV data of the AV signal inputted to the input part 3 is temporarily recorded on the sub-recording medium. In the post-stage part, the AV data is recorded in the optical disk 10 with a delay of a prescribed time or more after the input of the AV signal.

The sub-recording part 5 has a function for deleting the AV data decoded by the decoding part 6.

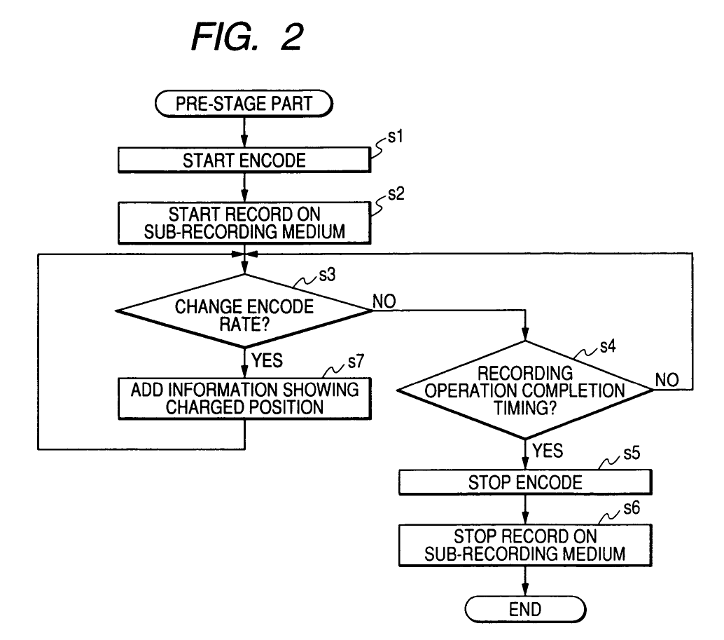

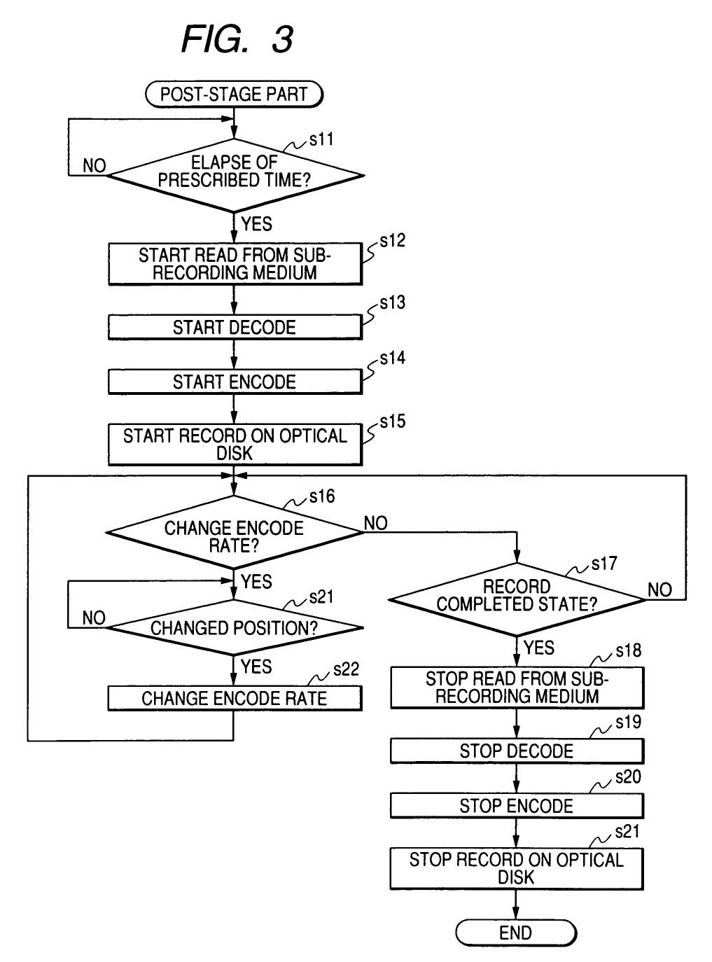

Now, a recording operation of the recorder 1 of this embodiment will be described below. FIGS. 2 and 3 are flowcharts showing the recording operation of the recorder of this embodiment. FIG. 2 shows processes of the pre-stage part of the recorder. FIG. 3 shows processes of the post-stage part of the recorder. The processes shown in FIG. 2 are performed in parallel with the processes shown in FIG. 3. The processes of the pre-stage part referred to herein are performed by the input part 3, the first encoding part 4 and the sub-recording part 5. The processes of the post-stage part are performed by the sub-recording part 5, the decoding part 6, the second encoding part 7 and the recording part 8.

Initially, the processes of the pre-stage part will be described. The recorder 1 starts to encode the AV signal inputted from the input part 3 at the encode rate of El in the first encoding part 4 (s1). At this time, the input part 3 extracts the television broadcasting signal of a selected channel and outputs the signal as the AV signal. The sub-recording part 5 starts to record the AV data encoded in the first encoding part 4 on the sub-recording medium (s2). The recorder 1 waits for a timing when an input operation for changing the setting of the encode rate is carried out in the operating part 9 or a timing when the recording operation is completed (s3, s4). It is the timing for completing the recording operation when an input operation for completing the recording operation is carried out by the user in the operating part 9 or when it is a time for completing a reserved image recording operation. When it is the timing for completing the recording operation, the recorder 1 stops processes started in the s1 and s2 (s5, s6) to finish main processes.

A case that an input operation for changing the setting of the encode rate is carried out in the operating part 9 will be described below.

As described above, in the pre-stage part, the AV signal is encoded at the minimum encode rate of E1 in the first encoding part 4 and the encoded AV data is recorded in the sub-recording part 5. Thus, the AV data is recorded on the sub-recording medium with such an image quality as to hardly lower the image quality (with the same image quality as that of the image by the AV signal inputted to the input part 3).

Further, the post-stage part waits for the elapse of a prescribed time (for instance, about 30 seconds) after the recording operation in the pre-stage part is started (s11). When the recorder 1 decides that the prescribed time elapses in the s11, the sub-recording part 5 starts a process for reading from the sub-recording part 5 in time series the AV data of the AV signal that is recorded for a prescribed time or more after the AV signal is inputted to the input part 3 and outputting the AV data to the decoding part 6 (s12). The sub-recording part 5 also performs a process for deleting the AV data outputted to the decoding part 6 in the s12 from the sub-recording part. As described below, the AV data outputted to the decoding part 6 by the sub-recording part 5 is recorded on the optical disk 10, so that even when the AV data is deleted, a problem does not occur. Further, since the AV data unnecessary for the sub-recording medium does not remain for a long time, the recording capacity of the sub-recording medium can be efficiently used and the recording capacity necessary for the sub-recording medium can be suppressed. Thus, a cost-up of a device main body can be restrained.

The decoding part 6 starts a process for decoding the AV data inputted from the sub-recording part 5 and outputting the decoded AV data to the second encoding part 7 (s13). Further, the second encoding part 7 starts a process for encoding the AV data inputted from the decoding part 6 at the set encode rate (any one of the encode rates E1 to E5) and outputting the encoded AV data to the recording part 8 (s14). Further, the recording part 8 starts a process for recording the AV data inputted from the second encoding part 7 on the optical disk 10 (s15). As apparent from the explanation, the AV data to be recorded by the recording part 8 (the AV data encoded in the second encoding part 7) is the data of the AV signal inputted to the input part 3 before a prescribed time or more.

When the recorder 1 starts to record the AV data on the optical disk 10 by the recording part 8 in the s15, the recorder 1 waits for a state that an input operation for changing the setting of the encode rate is carried out by the operating part 9 or a state that the sub-recording pat 5 reads all of the AV data recorded on the sub-recording medium by the recording operation of this time to record the AV data on the optical disk 10 (a recording completed state) (s16, s17).

When the input operation for changing the setting of the encode rate is carried out in the operating part 9, the control part 2 instructs the first encoding part 4 to add information showing the changing position of the encode rate to the encoded data of the AV signal inputted from the input part 3 at this time. Further, the control part 2 informs the second encoding part 7 of the change of the encode rate and a changed encode rate.

In the pre-stage part, the first encoding part 4 adds the information showing the changing position of the encode rate to the encoded data in accordance with an instruction from the control part 2 (s7) to return the process to the S3. The sub-recording part 5 records the added information showing the changing position of the encode rate in the sub-recording medium.

In the post-stage part, the second encoding part 7 is waited for detecting the information showing the changing position of the encode rate that is added to the AV signal inputted from the decoding part 6 (s21). In the s21, when the second encoding part detects the information showing the changing position of the encode rate, the second encoding part 7 changes an encode rata relative to the subsequently inputted AV data to the encode rate instructed from the control part 2 at this time (s22) to return the process to the s16.

An operation for changing the setting of the encode rate can be performed, as described above, by one-touch operation of a key provided for each of the encode rates E1 to E5. For instance, when the television broadcasting is changed from the main edition of a program to parts unnecessary for the user such as commercials or the explanation of the main edition of the program, the user performs a key operation for selecting the encode rate higher than that when the main edition of the program is recorded. When the commercials are changed to the main edition of the program, the user performs a key operation for selecting an original encode rate (an encode rate selected when the main edition of the program is previously recorded). The user performs such an operation so that the main edition of the program can be recorded at the relatively low encode rate so as not to deteriorate the image quality of a reproduced image, and the parts unnecessary for the user that are broadcast during the program can be recorded at the relatively high encode rate so as to suppress the recording capacity. Accordingly, the recording capacity of the optical disk 10 can be efficiently used and the maneuverability of the user can be improved. Further, since the AV signal inputted to the input part 3 is temporarily recorded on the sub-recording medium, and then, recorded on the optical disk 10 with a delay of a prescribed time or more, there is a deviation in time until the second encoding part 7 encodes the AV signal inputted to the input part 3 when the setting of the encode rate is changed. Accordingly, when the change of the setting of the encode rate is received, the setting of the encode rate relative to the AV signal inputted to the input part 3 can be smoothly changed. Advantageously, the record of the AV data of the AV signal inputted to the input part 3 is not interrupted when the change of the setting of the encode rate is received.

In the post-stage part, when the recording operation reaches its completed state, the operations of the sub-recording part 5, the decoding part 6, the second encoding part 7 and the recording part 8 are stopped to finish the main processes (s18 to s21).

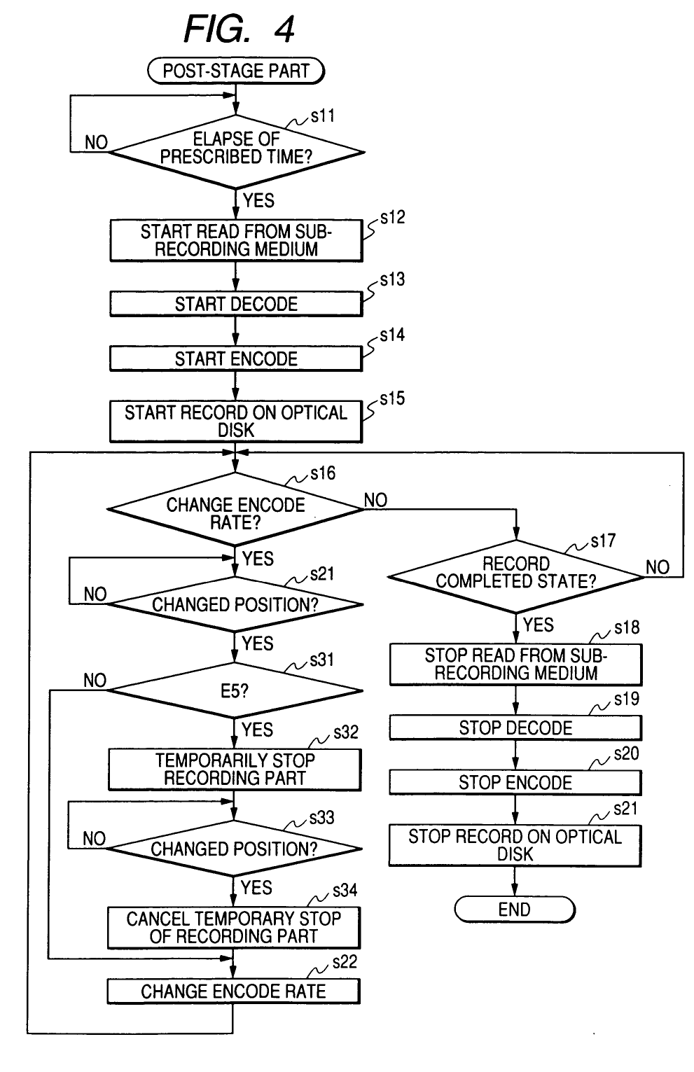

Further, in the above-described embodiment, the encode rate of the AV data to be recorded on the optical disk 10 is merely changed. However, a setting may be made in which the AV data is inhibited from being recorded on the optical disk 10. For instance, the encode rate of E5 in the above-described embodiment is set to inhibit the AV data from being recorded on the optical disk 10. As shown in FIG. 4, when the setting of the E5 is inputted (s31), the recording part 8 temporarily stops the record of the AV data in the optical disk 10 (s32). After that, an operation for changing the encode rate is carried out again to wait for positions showing that the setting of the E5 is changed to the setting of the encode rates of E1 to E4 (s33). Then, the temporary stop of the record of the AV data on the optical disk 10 is cancelled (s34). Then, the encode rate is changed to the encode rate set at this time in the s22 to return the process to the s16.

In such a way, the user can inhibit the AV data of the commercials broadcast during the main edition of the program from being recorded on the optical disk 10 so that the recording capacity of the optical disk 10 can be more efficiently used.

In the above description, only the recording process to the optical disk 10 in the recording part 8 is stopped. However, an encoding process in the second encoding part 7 or a decoding process in the decoding part 6 may be stopped.

Now, a reproducing device of an embodiment of the present invention will be described below.

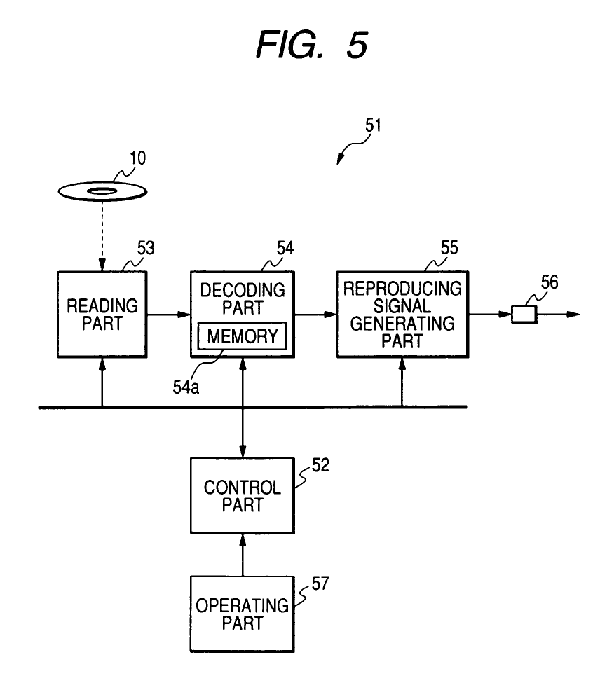

FIG. 5 is a diagram showing a structure of main parts of the reproducing device of this embodiment of the present invention. The reproducing device 51 of this embodiment is what is called a DVD player that reads moving image data recorded on a DVD 10 set in a main body and outputs a reproducing signal based on the read moving image data. The reproducing device 1 includes a control part 52 for controlling the operation of the main body, a reading part 53 for reading the moving image data recorded on the DVD 10 set in the main body, a decoding part 54 for decoding the moving image data read by the reading part 53 and a reproducing signal generating part 55 for generating the reproducing signal based on the moving image data decoded by the decoding part 54. Reference numeral 56 shown in FIG. 5 designates an output terminal for outputting the reproducing signal generated in the reproducing signal generating part 55 to an external part. To the output terminal 56, a device such as a television receiver is connected. 57 designates an operating part for performing an input operation to the main body.

The control part 52 gives to the reproducing signal generating part 55 instructions such as a start of reproduction, a stop of reproduction, a start of quick feed reproduction, a stop of quick feed reproduction, a start of rewind reproduction, a stop of rewind reproduction, etc. The reading part 53 has a well-known pick-up head (not shown) to apply a laser beam to the DVD 10, detect a reflected light and read the moving image data recorded on the DVD 10 thereby. The moving image data recorded on the DVD 10 is data encoded by an MPEG system. The decoding part 54 is provided with a memory 54a used for temporarily holding the moving image data read by the reading part 53 from the DVD 10 (encoded moving image data to be decoded by the decoding part 54) and used as a working area when the moving image data is decoded. The control part 52 monitors an amount of use of the memory 54a. The control part 52 decides whether or not the encode rate of the moving image data of a moving image during a reproducing operation is larger than a predetermined value on the basis of the amount of use of the memory 54a in the decoding part 54. The larger the encode rate of the moving image data (moving image data of a low bit rate) grows, the smaller the amount of use of the memory 54a during a decoding operation becomes. Accordingly, when the amount of use of the memory 54a for the moving image during the reproducing operation is lower than a predetermined amount of use, the moving image during the reproducing operation can be decided to be encoded at the encode rate larger than the predetermined value. The reproducing signal generating part 55 generates the reproducing signal based on the moving image data decoded by the decoding part 54 and outputs the reproducing signal to the external part through the output terminal 56. The moving image based on the reproducing signal outputted from the output terminal 56 is displayed on the television receiver connected to the output terminal 56.

The reproducing device 51 of this embodiment is provided with a skipping function for automatically setting the reproduction of the moving image data encoded at the encode rate larger than the predetermined value to a quick feed reproduction. The reproducing signal generating part 55 generates a frame-thinned reproducing signal to carry out the quick feed reproduction. Further, a user can freely set the skipping function to be valid or invalid. Specifically, the validity/invalidity of the skipping function can be switched by operating a special key provided in the operating part 57. The operating part 57 has a remote control receiving part for receiving a control signal to the main body transmitted from a remote controller not shown in the drawing. The control part 52 controls the operation of the main body in accordance with the control signal received by the remote control receiving part. The validity/invalidity of the skipping function can be switched by operating the remote controller.

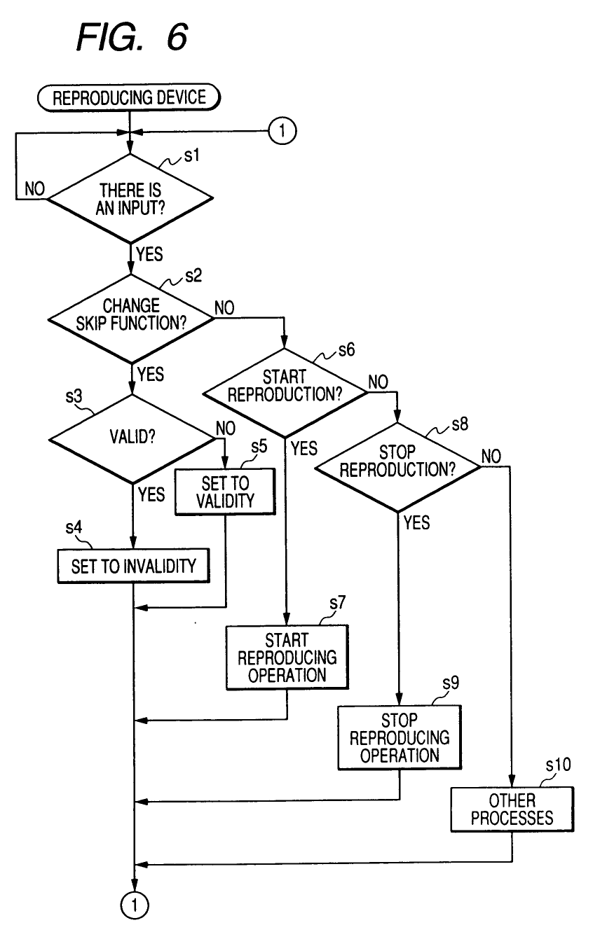

Now, an operation of the reproducing device 51 of the embodiment of the present invention will be described below. FIG. 6 is a flowchart showing the operation of the reproducing device of the embodiment according to the present invention. An optical disk device 1 waits for any input to the main body 51 (s1). In the s1, the reproducing device 51 waits for an operation that the key provided in the operating part 57 is operated or the remote control receiving part receives the control signal to the main body of the device. When there is an input to the main body, if the input of this time is an input for switching the validity/invalidity of the skipping function, the reproducing device 51 decides to which of the validity/invalidity the skipping function is set at this time (s2, S3). In the s3, when the reproducing device decides that the skipping function is set to the validity, the reproducing device sets the skipping function to invalidity (s4) to return to the s1. On the contrary, when the reproducing device decides that the skipping function is set to the invalidity in the s3, the reproducing device sets the skipping function to validity (s5) to return to the s1. Further, when the input of this time is an input for starting a reproducing operation, the reproducing device starts a below-described reproducing operation (s6, s7) to return to the s1. Further, when the input of this time is an input for stopping the reproducing operation, the reproducing device stops the reproducing operation that is started in the s7 and is being performed is stopped (s8, s9) to return to the s1. Still further, when the input of this time is an input other than the above-described inputs, the reproducing device carries out a process meeting the input of this time (other processes) (s10). Other processes carried out in the s10 include, for instance, an ejecting process of the DVD 10 set in the main body, a temporary stop process of the reproducing operation and a power tuning on/off process of the main body.

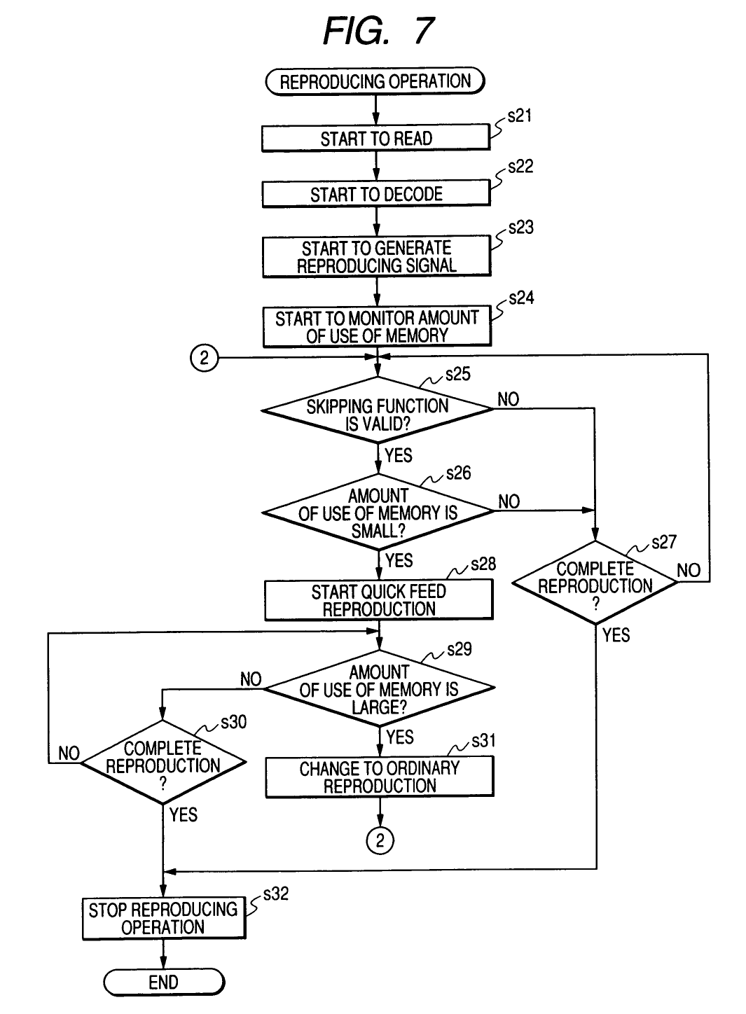

Now, the reproducing operation started in the s6 will be described. The reproducing operation is performed in parallel with the operation shown in FIG. 6. FIG. 7 is a flowchart showing the reproducing operation in the reproducing device of this embodiment according to the present invention. The control part 52 instructs the reading part 3 to start to read the moving image data recorded on the DVD 10 set in the main body (s21). In accordance with this instruction, the reading part 53 starts to read the moving image data recorded on the DVD 10. Further, the control part 52 instructs the decoding part 54 to start to decode the moving image data read by the reading part 53 from the DVD 10 (s22). In accordance with this instruction, the decoding part 54 starts to decode the moving image data. The moving image data read by the reading part 53 from the DVD 10 is temporarily held in the memory 54a. The decoding part 54 decodes the moving image data held in the memory 54a. At this time, the memory 54a is used as a working area. Further, the control part 52 instructs the reproducing signal generating part 55 to start to generate the reproducing signal based on the moving image data decoded by the decoding part 54 (s23). According to this instruction, the reproducing signal generating part 55 starts to generate the reproducing signal based on the moving image data decoded by the decoding part 54. The reproducing signal generated in the reproducing signal generating part 55 is inputted to the device such as the television receiver connected to the output terminal 56 through the output terminal 56. In the device connected to the output terminal 56, a moving image based on the reproducing signal generated by the reproducing signal generating part 55, that is, the moving image based on the moving image data recorded on the DVD is displayed.

The control part 52 starts to monitor an amount of use of the memory (s24). The control part 52 decides whether or not the skipping function is set to the validity (s25). When the skipping function is set to the validity, the control part detects that the amount of use of the memory 54a for the moving image during a reproducing operation is lower than a predetermined amount of use or waits for the completion of the reproduction of the moving image data recorded on the DVD 10 (s26, s27). On the contrary, when the control part decides that the skipping function is not set to the validity (set to the invalidity) in the s25, the control part waits for an operation that the moving image data recorded on the DVD 10 is completely reproduced in the s26. When the control part 52 decides that the amount of use of the memory 54a for the moving image during the reproducing operation is lower than the predetermined amount of use in the s26, that is, the encode rate of the moving image data of the moving image during the reproducing operation is larger than the predetermine value, the control part instructs the reproducing signal generating part 55 to start a quick feed reproduction (s28). The reproducing signal generating part 55 stops an ordinary reproduction that has been performed yet to start the quick feed reproduction in accordance with the instruction from the control part 52. Thus, in the device connected to the output terminal 56, a quickly fed and reproduced moving image is displayed.

Only when the skipping function is set to the validity, whether or not the amount of use of the memory 54a for the moving image during the reproducing operation is lower than the predetermined amount of use is decided in the s26. When the skipping function is set to the invalidity, the decision in the s26 is not carried out.

The control part 52 waits for a state that the amount of use of the memory 54a for the moving image quickly fed and reproduced is higher than the predetermined amount of use or the moving image data recorded on the DVD 10 is completely reproduced (s29, s30). When the control part 52 decides that the amount of use of the memory 54a for the moving image quickly fed and reproduced is higher than the predetermined amount of use, that is, the encode rate of the moving image data of the moving image during the reproducing operation is smaller than the predetermined value, the control part instructs the reproducing signal generating part 55 a position a prescribed time (for instance, 1 to 2 seconds) before a position where the moving image data having the amount of use of the memory 54a lower than the predetermined amount of use is changed to the moving image data having the amount of use of the memory higher than the predetermined amount of use as a position where the quick feed reproduction is changed to the ordinary reproduction (s31) and returns to the s25. The reproducing signal generating part 55 returns to the position instructed this time by the control part 52 to stop the quick feed reproduction and start the ordinary reproduction. At this time, while the reproducing signal generating part returns to the start position of the ordinary reproduction, a rewind reproduction maybe carried out.

Further, when the control part 52 decides that the moving image data recorded in the DVD 10 is completely reproduced in the s27 or the s30, the control part respectively stops the reproducing operations of the parts for reproducing the moving image data recorded on the DVD 10 (s32) to finish the main process.

Even when the moving image data recorded on the DVD 10 is not completely reproduced, if there is an input for stopping the reproducing operation in the operating part 57, the reproducing device 51 stops the operations of the respective parts for reproducing the moving image data recorded on the DVD 10 to finish the reproducing operation.

As described above, when the skipping function is set to the validity, the reproducing device 51 of this embodiment automatically switches the moving image data recorded on the DVD 10 and having the encode rate larger than the predetermined value to the quick feed reproduction, and, the moving image data having the encode rate smaller than the predetermined value to the ordinary reproduction. When most of users who use lately proposed recorders that can change the encode rate of the moving image data to be recorded on the DVD 10 record a program of a television broadcasting on the DVD 10, to efficiently use the recording capacity of the DVD 10, they record the main edition of the program at the relatively low encode rate so as to suppress the deterioration of the image quality of a reproduced image, however, they increase the encode rate for parts unnecessary for the users such as commercials or the explanation of the main edition of the program broadcast during the main edition of the program so as to more suppress the recording capacity than the deterioration of the image quality. In the DVD 10 in which the parts unnecessary for the user are recorded at the higher encode rate than that of the main edition of the program, the commercial part is automatically quickly fed and reproduced during the reproduction, so that the operability of the user can be improved.

The reproducing device 1 of this embodiment may include a function for changing the encode rate of the moving image data to be recorded on the DVD 10 to record the moving image data.

Further, since the user can switch the validity/invalidity of the skipping function, the moving image data having the encode rate higher than the predetermined encode rate can be viewed under the ordinary reproduction by setting the skipping function to the invalidity.

Further, when the quick feed reproduction is switched to the ordinary reproduction, since the quick feed reproduction is returned to the ordinary reproduction at a position a prescribed time (for instance, 1 to 2 seconds) before a position where the moving image data having the encode rate higher than the predetermined encode rate is changed to the moving image data having the encode rate lower than the predetermined encode rate, a situation is prevented from arising that a moving image is disturbed immediately after the parts unnecessary for the user are changed to the main edition of the program to hinder the user from viewing the main edition of the program.

In the above-described embodiment, the present invention is explained by employing the reproducing device for reproducing the moving image data recorded on the DVD 10 as an example. However, a recording medium for recording the moving image data may be other kinds of recording media such as a hard disk.

Now, an editor of an embodiment of the present invention will be described below.

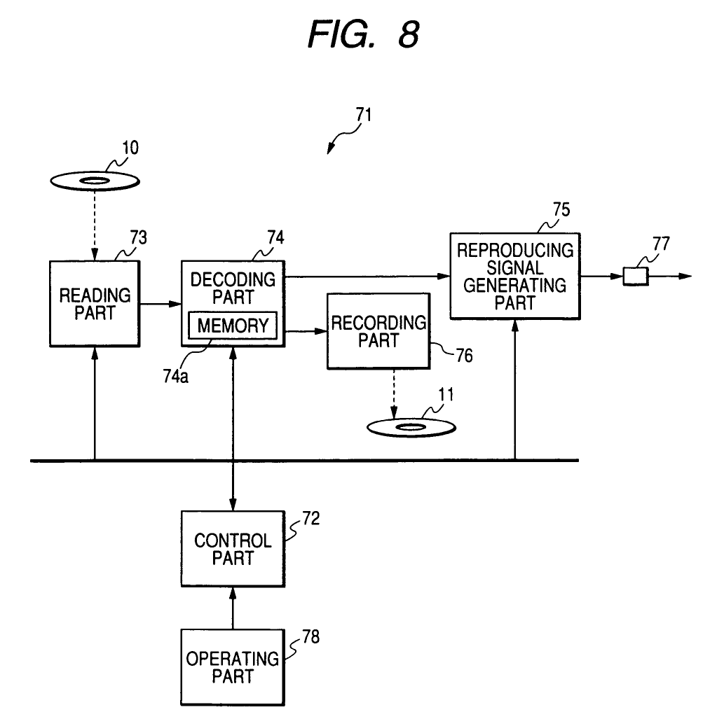

FIG. 8 is a diagram showing the structure of main parts of an editor of an embodiment of the present invention. The editor 71 of this embodiment has en editing function for editing in such a way that moving image data recorded on one DVD 10 (referred to as a first recording medium in the present invention) set in a main body, a reproducing signal based on the read moving image data is outputted and the moving image data of the outputted reproducing signal is recorded on the other DVD 11 (referred to as a second recording medium in the present invention). The editor 71 includes a control part 72 for controlling the operation of the main body, a reading part 73 for reading the moving image data recorded on the DVD 10 set in the main body, a decoding part 74 for decoding the moving image data read by the reading part 73, a reproducing signal generating part 75 for generating the reproducing signal based on the moving image data decoded by the decoding part 74 and a recording part 76 for recording the moving image data of a moving image reproduced by the reproducing signal generated by the reproducing signal generating part 75 on another DVD 11 set in the main body. Reference numeral 77 shown in FIG. 8 designates an output terminal for outputting the reproducing signal generated in the reproducing signal generating part 75 to an external part. To the output terminal 77, a device such as a television receiver is connected. 78 designates an operating part for performing an input operation to the main body.

The control part 72 gives to the reproducing signal generating part 75 instructions such as a start of reproduction, a stop of reproduction, a start of quick feed reproduction, a stop of quick feed reproduction, a start of rewind reproduction, a stop of rewind reproduction, etc. The reading part 73 has a well-known pick-up head (not shown) to apply a laser beam to the DVD 10, detect a reflected light thereof and read the moving image data recorded on the DVD 10 thereby. The moving image data recorded on the DVD 10 is data encoded by an MPEG system. The control part 72 further instructs the reading part 73 to start to read the moving image data from the DVD 10 and to stop to read the data.

The decoding part 74 is provided with a memory 74a used for temporarily holding the moving image data read by the reading part 73 from the DVD 10 (encoded moving image data to be decoded by the decoding part 74) and used as a working area when the moving image data is decoded. The control part 72 monitors an amount of use of the memory 74a. The control part 72 decides whether or not the encode rate of the moving image data of a moving image during a reproducing operation is larger than a predetermined value on the basis of the amount of use of the memory 74a in the decoding part 74. The larger the encode rate of the moving image data (moving image data of a low bit rate) grows, the smaller the amount of use of the memory 74a during a decoding operation becomes. Accordingly, when the amount of use of the memory 74a for the moving image during the reproducing operation is lower than a predetermined amount of use, the moving image during the reproducing operation can be decided to be encoded at the encode rate larger than the predetermined value. The reproducing signal generating part 75 generates the reproducing signal based on the moving image data decoded by the decoding part 74 and outputs the reproducing signal to the external part through the output terminal 77. The moving image based on the reproducing signal outputted from the output terminal 77 is displayed on the television receiver connected to the output terminal 77.

Further, the recording part 76 has a pick-up head like the reading part 73 and applies a laser beam to the DVD 11 to record the moving image data. The recording part 76 directly records the moving image data read from the DVD 10 by the reading part 73 on the DVD 11. Specifically, the recording part records the moving image data before decoded by the decoding part 74 on the DVD 11. The control part 72 gives to the recording part 76 instructions such as a start of record of the moving image data, a stop of record, a temporary stop of record and a cancel of temporary stop.

The editor 71 of this embodiment is provided with a skipping function for automatically setting the reproduction of the moving image data encoded at the encode rate larger than the predetermined value to a quick feed reproduction. The reproducing signal generating part 75 generates a frame-thinned reproducing signal to carry out the quick feed reproduction. Further, a user can freely set the skipping function to be valid or invalid. Specifically, the validity/invalidity of the skipping function can be switched by operating a special key provided in the operating part 78. Further, in the editor 71 of this embodiment, a cutting function is provided for automatically inhibiting the moving image data encoded at the encode rate larger than the predetermined value in the DVD 10 from being recorded on the DVD 11. The cutting function can be freely set to be valid or invalid by the user like the skipping function. The operating part 78 has a remote control receiving part for receiving a control signal to the main body transmitted from a remote controller not shown in the drawing. The control part 72 controls the operation of the main body in accordance with the control signal received by the remote control receiving part. The validity/invalidity of the skipping function or the cutting function can be switched by operating the remote controller.

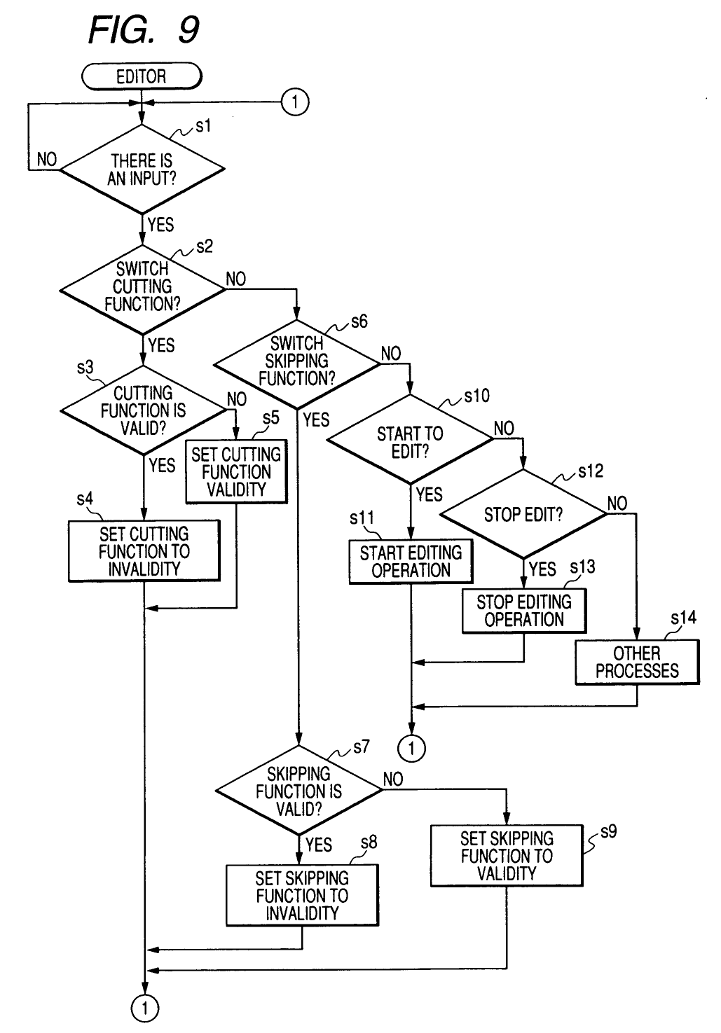

Now, an operation of the editor 71 of the embodiment of the present invention will be described below. FIG. 9 is a flowchart showing the operation of the editor of the embodiment according to the present invention. The editor 71 waits for any input to the main body (s1). In the s1, the editor 71 waits for an operation that the key provided in the operating part 78 is operated or the remote control receiving part receives the control signal to the main body of the device. When there is an input to the main body, if the input of this time is an input for switching the validity/invalidity of the cutting function (CM cutting function), the editor 71 decides to which of the validity/invalidity the cutting function is set at this time (s2, S3). In the s3, when the editor decides that the cutting function is set to the validity, the editor sets the cutting function to invalidity (s4). On the contrary, when the editor decides that the cutting function is set to the invalidity in the s3, the editor sets the cutting function to validity (s5) to return to the s1. Further, when the input of this time is an input for switching the validity/invalidity of the skipping function, the editor 1 decides to which of the validity/invalidity the skipping function is set at this time (s6, S7). In the s7, when the editor decides that the skipping function is set to the validity, the editor sets the skipping function to invalidity (s8) to return to the s1. On the contrary, when the editor decides that the skipping function is set to the invalidity in the s7, the editor sets the skipping function to validity (s9) to return to the s1. Further, when the input of this time is an input for starting an editing operation, the editor starts a below-described editing operation (s10, s11) to return to the s1. Further, when the input of this time is an input for stopping the editing operation, the editor stops (s12, s13) the editing operation that is started in the s11 and is being performed to return to the s1. Still further, when the input of this time is an input other than the above-described inputs, the editor carries out a process meeting the input of this time (other processes) (s14). Other processes carried out in the s14 include, for instance, an ejecting process of the DVD 10 set in the main body, a start and stop of the reproducing operation and a power tuning on/off process of the main body.

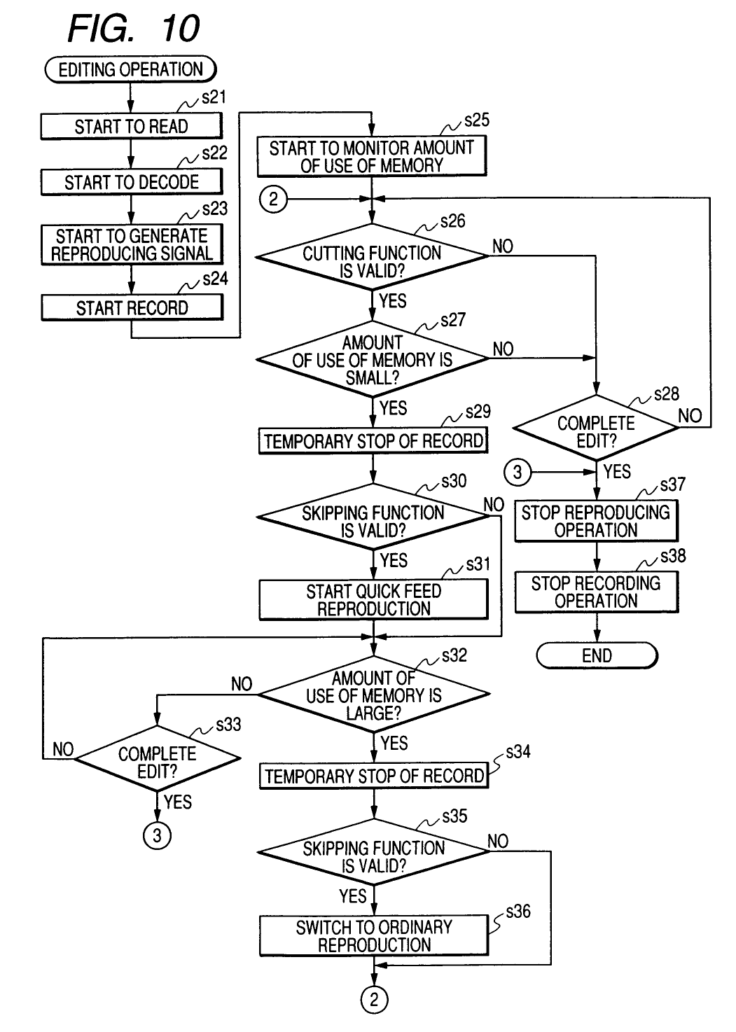

Now, the editing operation started in the s11 will be described. The editing operation is performed in parallel with the operation shown in FIG. 9. FIG. 10 is a flowchart showing the editing operation in the editor of this embodiment according to the present invention. The control part 72 instructs the reading part 73 to start to read the moving image data recorded on the DVD 10 set in the main body (s21). In accordance with this instruction, the reading part 73 starts to read the moving image data recorded on the DVD 10. Further, the control part 72 instructs the decoding part 74 to start to decode the moving image data read by the reading part 73 from the DVD 10 (s22). In accordance with this instruction, the decoding part 74 starts to decode the moving image data. The moving image data read by the reading part 73 from the DVD 10 is temporarily held in the memory 74a. The decoding part 74 decodes the moving image data held in the memory 74a. At this time, the memory 74a is used as a working area. Further, the control part 72 instructs the reproducing signal generating part 75 to start to generate the reproducing signal based on the moving image data decoded by the decoding part 74 (s23). According to this instruction, the reproducing signal generating part 75 starts to generate the reproducing signal based on the moving image data decoded by the decoding part 74. The reproducing signal generated in the reproducing signal generating part 75 is inputted to the device such as the television receiver connected to the output terminal 77 through the output terminal 77. In the device connected to the output terminal 77, a moving image based on the reproducing signal generated by the reproducing signal generating part 75, that is, the moving image based on the moving image data recorded on the DVD is displayed.

Further, the control part 72 instructs the recording part 76 to start to record the moving image data of the moving image that is reproduced by the reproducing signal generated in the reproducing signal generating part 75 on the DVD 11 (s24). In accordance with this instruction, the recording part 76 starts to record the moving image data of the moving image during the reproducing operation on the DVD 11. The recording part 76 records on the DVD 11 the moving image data of the moving image during the reproducing operation that is read from the DVD 10 by the reading part 73 and temporarily held in the memory 74a of the decoding part 74. In other words, the recording part 76 records the moving image data recorded on the DVD 10 directly on the DVD 11.

The control part 72 starts to monitor an amount of use of the memory 74a (s25). The control part 72 decides whether or not the cutting function is set to the validity (s26). When the cutting function is set to the validity, the control part detects that the amount of use of the memory 74a for the moving image during the reproducing operation is lower than a predetermined amount of use or waits for the completion of the editing operation of the moving image data recorded on the DVD 10 (s27, s28). On the contrary, when the control part decides that the cutting function is not set to the validity (set to the invalidity) in the s26, the control part waits for an operation that the moving image data recorded on the DVD 10 is completely edited in the s28 (the decision of s27 is not preformed.) When the control part 72 decides that the amount of use of the memory 74a for the moving image during the reproducing operation is lower than the predetermined amount of use in the s27, that is, the encode rate of the moving image data of the moving image during the reproducing operation is larger than the predetermine value, the control part instructs the recording part 76 to temporarily stop the record of the moving image data during the reproducing operation on the DVD 11 (s29). The recording part 6 temporarily stops the record of the moving image data of the moving image during the reproducing operation on the DVD 11 in accordance with this instruction. The control part 72 decides whether or not the skipping function is set to the validity (s30). When the skipping function is set to the validity, the control part instructs the reproducing signal generating part 5 to start a quick feed reproduction (s31). The reproducing signal generating part 75 stops an ordinary reproduction that has been performed yet to start the quick feed reproduction in accordance with the instruction from the control part 72. Thus, in the device connected to the output terminal 77, a quickly fed and reproduced moving image is displayed. When the skipping function is set to the invalidity, the control part 72 does not give the instruction of s31 and the ordinary reproduction is continuously carried out in the reproducing signal generating part 75.

As described above, only when the cutting function is set to the validity, whether or not the amount of use of the memory 74a for the moving image during the reproducing operation is lower than the predetermined amount of use is decided in the s27. When the cutting function is set to the invalidity, the decision in the s27 is not carried out.

The control part 72 waits for a state that the amount of use of the memory 74a for the moving image quickly fed and reproduced or ordinarily reproduced is higher than the predetermined amount of use or the moving image data recorded on the DVD 10 is completely reproduced (s32, s33). When the control part 72 decides that the amount of use of the memory 74a for the moving image quickly fed and reproduced or ordinarily reproduced is higher than the predetermined amount of use in the s32, that is, the encode rate of the moving image data of the moving image during the reproducing operation is smaller than the predetermined value, the control part 72 instructs the recording part 76 to cancel the temporary stop of the record of the moving image data on the DVD 11 that is instructed in the s29 (s34). When the reproducing signal generating part 75 performs the quick feed reproduction, the control part 72 instructs the reproducing signal generating part 75 to return to the ordinary reproduction from the quick feed reproduction (s35, s36) to return to the s26. The recording part 76 resumes the record of the moving image data of the moving image during the reproducing operation on the DVD 11 in accordance with the instruction of s34. Further, the reproducing signal generating part 75 that performs the quick feed reproduction stops the quick feed reproduction in accordance with the instruction of s36 to start the ordinary reproduction.

Further, when the control part 72 decides the editing operation is completed that the moving image data recorded in the DVD 10 is recorded on the DVD 11 in the s28 or the s33, the control part respectively stops the reproducing operations of the parts for reproducing the moving image data recorded on the DVD 10 and stops the recording operation of the moving image data on the DVD 11 in the recording part 76 (s37, s38) to finish the main process.

Even when the editing operation for recording the moving image data recorded on the DVD 10 on the DVD 11 is not completed, if there is an input for stopping the editing operation in the operating part 78, the editor stops the operations of the respective parts for reproducing the moving image data recorded on the DVD 10 and the recording operation of the moving image data on the DVD 11 in the recording part 76 to finish the editing operation of this time.

As described above, when the cutting function is set to the validity, the editor 71 of this embodiment automatically inhibits the moving image data recorded on the DVD 10 and having the encode rate larger than the predetermined value from being recorded on the DVD 11 (temporarily stop the record of the moving image data on the DVD 11), and, records the moving image data having the encode rate smaller than the predetermined value on the DVD 11. When most of users who use recorders that can change the encode rate of the moving image data to be recorded on the DVD 10 record a program of a television broadcasting on the DVD 10, to efficiently use the recording capacity of the DVD 10, they record the main edition of the program at the relatively low encode rate so as to suppress the deterioration of the image quality of a reproduced image, however, they increase the encode rate for parts unnecessary for the users such as commercials or the explanation of the main edition of the program broadcast during the main edition of the program so as to more suppress the recording capacity than the deterioration of the image quality. As described above, in the DVD 10 in which the parts unnecessary for the user are recorded at the higher encode rate than that of the main edition of the program, when the cutting function is merely set to the validity for the editing operation by the editor 1 of this embodiment, the unnecessary parts for the user are automatically cut and only the moving image data of the main edition of the program can be recorded on the DVD 11. Accordingly, the editing operation for cutting the unnecessary parts for the user can be simply carried out to improve the operability of the user.

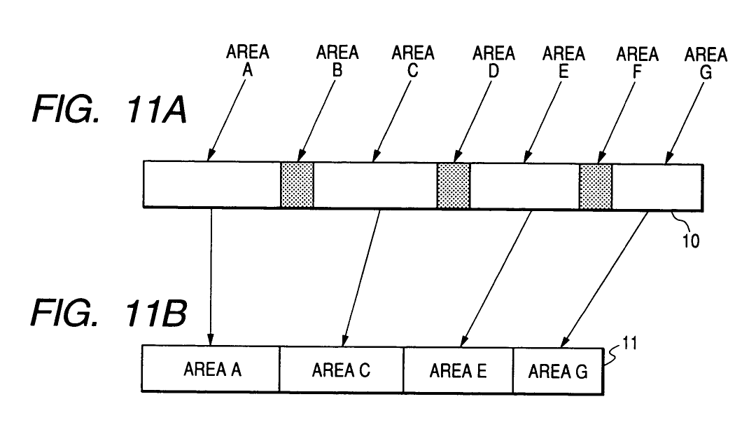

Specifically, as shown in FIG. 11A, when moving images recorded in recording areas A, C, E and G of the DVD 10 are the moving images of the main edition of a program recorded at the relatively low encode rate (encode rate smaller than a predetermined level), and moving images recorded in recording areas B, D and F are the moving images of unnecessary parts for the user recorded at the relatively high encode rate (encode rate larger than a predetermined level), if the cutting function is set to the validity to perform the editing operation, as shown in FIG. 11B, only the moving image data of the main edition of the program recorded in the recording areas A, C, E and G of the DVD 10 is recorded in the DVD 11 and the moving image data of the unnecessary parts for the user that is recorded in the recording areas B, D and F is not recorded. Further, since the user views the moving image data recorded on the DVD 10 at least once, the editing operation may be carried out during viewing the data to cut the unnecessary parts for the user.

In the editing operation, when the skipping function is set to the validity, the moving image data that is not recorded on the DVD 11, that is, the moving image data of the unnecessary parts for the user is quickly fed and reproduced. Accordingly, the reproducing time of these parts can be shortened during the editing operation. As a result, a time necessary for the editing operation can be reduced.

Further, since the user can freely set the cutting function to validity/invalidity, the DVD 10 in which the moving image data is recorded at the encode rate higher than the predetermined encode rate may be used to perform the editing operation for the DVD 11.

Further, since the moving image data read from the DVD 10 by the reading part 73 is directly recorded on the DVD 11, a reproduced image by the moving image data recorded in the DVD 11 under the editing operation has the same image quality as that of a reproduced image by the moving image data recorded on the DVD 10. In other words, the image quality is not deteriorated by the editing operation.

In the above-described embodiment, an explanation is given to the editor for recording the moving image data recorded in the DVD 10 on another DVD 11 as an example. However, the present invention is not limited to the editing operation of images between the DVDs. The present invention may be applied any of devices in which the moving image data can be edited between recording media such as a hard disk to a DVD, a DVD to a hard disk and hard disks. When the moving image data that is recorded is recorded on another recording medium, the moving image data recorded on the original recording medium to be edited is not necessary for the user with high possibility. Thus, are-writable recording medium is preferably used as the recording medium for recording original moving image data to be edited.

What is claimed is:

1. A recorder having a recording unit for recording an inputted image on an optical disk, the recorder comprising:
an image input receiving unit for receiving the input of the image;
a first encoding unit for encoding the image received by the image input receiving unit;
a sub-recording unit for recording image data encoded by the first encoding unit on a sub-recording medium;
a decoding unit for decoding the image data recorded on the sub-recording medium by the sub-recording unit;
a second encoding unit for encoding the image data decoded by the decoding unit at a set encode rate; and
an encode rate receiving unit for receiving the set input of the encode rate in the second encoding unit,
wherein the recording unit serves to record the image data encoded by the second encoding unit on the optical disk, the first encoding unit serves to encode the image received by the image input receiving unit at a prescribed encode rate, the decoding unit serves to decode the image data of the image whose input is received by the image input receiving unit before a predetermined time or more, the second encoding unit serves to encode an image subsequently received by the image input receiving unit at a setting changed encode rate, when the encode rate receiving unit receives an input of the setting change of the encode rate, the sub-recording unit has a function for deleting the image data decoded by the decoding unit, the encode rate receiving unit serves to receive a selection of the encode rates that are previously determined stepwise, the first encoding unit serves to encode the image received by the image input receiving unit at the lowest encode rate of the encode rates that are previously determined stepwise, and the encode rate receiving unit serves to receive a setting input for inhibiting the image data decoded by the decoding unit from being recorded on the optical disk by the recording unit.

2. A recorder having a recording unit for recording an inputted image on an optical disk, the recorder comprising:
an image input receiving unit for receiving the input of the image;
a first encoding unit for encoding the image received by the image input receiving unit;
a sub-recording unit for recording image data encoded by the first encoding unit on a sub-recording medium;
a decoding unit for decoding the image data recorded on the sub-recording medium by the sub-recording unit;
a second encoding unit for encoding the image data decoded by the decoding unit at the set encode rate; and
an encode rate receiving unit for receiving the set input of the encode rate in the second encoding unit,
wherein the recording unit serves to record the image data encoded by the second encoding unit on the optical disk, the first encoding unit serves to encode the image received by the image input receiving unit at a prescribed encode rate, the decoding unit serves to decode the image data of the image whose input is received by the image input receiving unit before a predetermined time or more, and the second encoding unit serves to encode an image subsequently received by the image input receiving unit at a setting changed encode rate, when the encode rate receiving unit receives an input of the setting change of the encode rate.

3. The recorder according to claim 2, wherein the sub-recording unit has a function for deleting the image data decoded by the decoding unit.

4. The recorder according to claim 2, wherein the encode rate receiving unit serves to receive a selection of the encode rates that are previously determined stepwise and the first encoding unit serves to encode the image received by the image input receiving unit at the lowest encode rate of the encode rates that are previously determined stepwise.

5. The recorder according to claim 2, wherein the encode rate receiving unit serves to receive a setting input for inhibiting the image data decoded by the decoding unit from being recorded on the optical disk by the recording unit.

6. A reproducing device comprising:
a reading unit for reading moving image data encoded from a recording medium;
a decoding unit for decoding the moving image data read by the reading unit;
a reproducing unit for generating a reproducing signal based on the moving image data decoded by the decoding unit and outputting the reproducing signal;
a deciding unit for temporarily holding the moving image data decoded by the decoding unit and deciding whether or not the encode rate of the moving image data of a moving image during a reproducing operation is higher than a predetermined level on the basis of an amount of use of a memory employed as a working area during a decoding operation;
a skipping unit for instructing the reproducing unit to start a quick feed reproduction when the deciding unit decides that the encode rate is higher than the predetermined level, and then, instructing the reproducing unit to return to an ordinary reproduction from the quick feed reproduction when the deciding unit decides that the encode rate is lower than the predetermined level; and
a switching unit for switching whether the skipping unit is made to be valid or invalid,
wherein when the reproducing unit is instructed to return to the ordinary reproduction from the quick feed reproduction by the skipping unit, the reproducing unit resumes the ordinary reproduction from a position where the reproducing unit returns by a prescribed amount on this side of a position where the moving image data of the encode rate higher than the predetermined level is changed to the moving image data of the encode rate lower than the predetermine level.

7. A reproducing device comprising:
a reading unit for reading moving image data encoded from a recording medium;
a decoding unit for decoding the moving image data read by the reading unit;
a reproducing unit for generating a reproducing signal based on the moving image data decoded by the decoding unit and outputting the reproducing signal;
a deciding unit for temporarily holding the moving image data decoded by the decoding unit and deciding whether or not the encode rate of the moving image data of a moving image during a reproducing operation is higher than a predetermined level on the basis of an amount of use of a memory employed as a working area during a decoding operation; and
a skipping unit for instructing the reproducing unit to start a quick feed reproduction when the deciding unit decides that the encode rate is higher than the predetermined level, and then, instructing the reproducing unit to return to an ordinary reproduction from the quick feed reproduction when the deciding unit decides that the encode rate is lower than the predetermined level.

8. A reproducing device according to claim 7, wherein when the reproducing unit is instructed to return to the ordinary reproduction from the quick feed reproduction by the skipping unit, the reproducing unit resumes the ordinary reproduction from a position where the reproducing unit returns by a prescribed amount on this side of a position where the moving image data of the encode rate higher than the predetermined level is changed to the moving image data of the encode rate lower than the predetermine level.

9. A reproducing device according to claim 7, further including a switching unit for switching whether the skipping unit is made to be valid or invalid.

10. An editor having a reading unit for reading moving image data encoded from a first recording medium; a decoding unit for decoding the moving image data read by the reading unit; and a reproducing unit for generating a reproducing signal based on the moving image data decoded by the decoding unit and outputting the reproducing signal, the reproducing unit including a recording unit for recording the moving image data of a moving image during a reproducing operation on a second recording medium, said editor comprising:
a deciding unit for temporarily holding the moving image data decoded by the decoding unit and deciding whether or not the encode rate of the moving image data of a moving image during a reproducing operation is higher than a predetermined level on the basis of an amount of use of a memory employed as a working area during a decoding operation;
a record inhibiting unit for inhibiting the recording unit from recording the moving image data of the moving image during the reproducing operation on the second recording medium while the reproducing unit reproduces the moving image data having the encode data decided to be higher than the predetermined level by the deciding unit;
a skipping unit for instructing the reproducing unit to start a quick feed reproduction when the deciding unit decides that the encode rate is higher than the predetermined level, and then, instructing the reproducing unit to return to an ordinary reproduction from the quick feed reproduction when the deciding unit decides that the encode rate is lower than the predetermined level; and
a switching unit for switching whether the recording unit is made to be valid or invalid, wherein the recording unit is a unit for directly recording the moving image data read from the first recording medium by the reading unit on the second recording medium.

11. An editor having a reading unit for reading moving image data encoded from a first recording medium; a decoding unit for decoding the moving image data read by the reading unit; and a reproducing unit for generating a reproducing signal based on the moving image data decoded by the decoding unit and outputting the reproducing signal, the reproducing unit including a recording unit for recording the moving image data of a moving image during a reproducing operation on a second recording medium, said editor comprising:
a deciding unit for temporarily holding the moving image data decoded by the decoding unit and deciding whether or not the encode rate of the moving image data of the moving image during the reproducing operation is higher than a predetermined level on the basis of an amount of use of a memory employed as a working area during a decoding operation; and
a record inhibiting unit for inhibiting the recording unit from recording the moving image data of the moving image during the reproducing operation on the second recording medium while the reproducing unit reproduces the moving image data having the encode data decided to be higher than the predetermined level by the deciding unit.

12. The editor according to claim 11, wherein the recording unit is a unit for directly recording the moving image data read from the first recording medium by the reading unit on the second recording medium.

13. The editor according to claim 11, further comprising a switching unit for switching whether the recording unit is made to be valid or invalid.

14. The editor according to any one of claim 11, further comprising a skipping unit for instructing the reproducing unit to start a quick feed reproduction when the deciding unit decides that the encode rate is higher than the predetermined level, and then, instructing the reproducing unit to return to an ordinary reproduction from the quick feed reproduction when the deciding unit decides that the encode rate is lower than the predetermined level.
